(19) United States
(12) Patent Application Publication
(10) Pub. No.: US 2020/0230801 A1
(43) Pub. Date: Jul. 23, 2020

(54) Inclusive Socket and Tool Organizer

(71) Applicant: Bijan Nik Moradi, Tampa, FL (US)

(72) Inventor: Bijan Nik Moradi, Tampa, FL (US)

(21) Appl. No.: 16/252,668

(22) Filed: Jan. 20, 2019

(51) Int. Cl. B25H 3/00; B25H 3/02

(52) U.S. Cl. CPC B25H 3/003; B25H 3/028

(57) ABSTRACT

The present invention includes a transportable container for organizing various hand tools and hand tool attachments. The transportable container has a handle, drawer, raised periphery edges, cavities for individually storing and retaining hand tool attachments, and one or more labels. The hand tool attachments in the cavities are arranged in order based on incremental shape, size, drive size, or a combination thereof. The one or more labels identifying the shape, size, drive size, or a combination thereof of an individualized hand tool attachment position within the container.

### BACKGROUND

The present invention relates generally to storage and organization of tools and/or tool accessories. More specifically, the present invention relates to a transportable container having visible labels with cavities for systematically storing and organizing individual sockets. Furthermore, the present invention includes a drawer for storage of socket wrenches, socket adapters, and socket extensions.

Socket wrenches and sockets are ubiquitous tools used in a wide variety of commercial and residential applications such as automotive mechanics, home repair, industrial applications, etc. A typical socket wrench is comprised of a bar with a handle on one end with the opposing end having a universal drive square that commonly comes in one of three sizes (i.e. ¼ in, ⅜ in, and ½ in). A removable socket is shaped with openings on each end. One end is shaped in a manner to fit one of the universal drive square sizes and the other end comes in a variety of sizes to fit the utility of that specific socket. The socket fits a nut or bolt to loosen or tighten the nut or bolt as desired. Each socket is commonly sold as a set of sockets for a particular sized socket wrench such that a set of sockets may vary in drive depth, diameter, and shape.

The holding means that keeps the socket attached to the socket wrench is the drive square, also known as the drive nub. This portion of the wrench is responsible for retaining the socket and may also allow for ratcheting means, such as, a swiveling hinge or universal joint.

The body of most sockets is shaped as a circular cylinder and markings, etchings, or other types of labeling on the body depict the size of that particular socket. The variably sized and shaped opening of the socket is a particular shape, depth, and diameter to properly and snugly fit a nut or bolt such that the nut or bolt can be loosened or tightened as desired.

Considering the vast array of different possible socket sizes, shapes, and diameters, it is common for one to become quickly frustrated when trying to quickly and efficiently determine and obtain the proper socket to be used for a particular job. Furthermore, that frustration is enhanced when the proper socket wrench, adapter, or extension is not immediately available from the same carrier from which the socket was obtained.

As such, it is desirable to have a system that stores and systematically organizes various individual and sets of sockets in a single place. It is also desirable that this system be portable to keep multiple socket options available for the job at hand. It is also desirable that this same system store options for socket wrenches, adapters, and extensions so as to maximize efficiency and minimize frustration. Keeping sockets organized and stored in such a system also offers the benefit of limiting damage to the sockets and other tools as well as avoiding socket loss. Further, it would be desired that the sockets be easily stored and removed without significant resistance.

Multiple means of storing sockets and wrenches have been proposed and used. In U.S. Pat. No. 4,353,465 to Rado, for example, a tray having a plurality of seats having retainers is show. Each socket is placed over retainers whereby the retainer is slightly urged together to provide a spring force to secure the socket. Unfortunately, the retainers can lose resilency over time, become lost, and add weight to the overall tray thereby making it less transportable. Also, there is no area for storage of wrenches, extensions, or adapters. Further, the socket sizes are not labeled on the tray for easily identification.

In U.S. Pat. No. 5,154,544 to Arendt describes an organizing and storage device having a planar base with a plurality of round cylindrical posts projecting upward from the base. The posts are sized to accept different socket sizes. The difficulty with this method is that the base is not easily transportable and the socket sizes are not readily identifiable to the user.

In U.S. Pat. Nos. 6,571,669 and 6,808,067, both to Benatz et al., is described a socket wrench organizer with a top socket holder and bottom socket holder, whereby the sockets are secured in place by a magnet. This organizer is transportable, but is significantly limited in the number of sockets being held. Further, the sizes of the sockets are not identified.

In U.S. Pat. No. 7,424,953 to McCarty et al., is described a socket container that is comprised of a base with 4 walls and labeled areas for sockets. It is transportable, but is significant limited in the fact that it lacks an area for storage and transportation of socket wrenches, extensions, and adaptors.

Thus, what is desirable is a transportable storage and organizing means for sockets, socket wrenches, extensions, and adaptors. This system should be able to store and transport varied sets of sockets or other similar accessories in an organized and cost-effective way.

### BRIEF DESCRIPTION OF DRAWINGS

The various exemplary embodiments of the present invention, which will become more apparent as the description proceeds, are described in the following detailed description in conjunction with the accompanying drawings, in which:

FIG. 1 is a perspective view of an exemplary embodiment of the present invention.

FIG. 2 is a front view of an exemplary embodiment of the present invention.

FIG. 3 is a top view of an exemplary embodiment of the present invention.

FIG. 4 is a view from one side of an exemplary embodiment of the present invention.

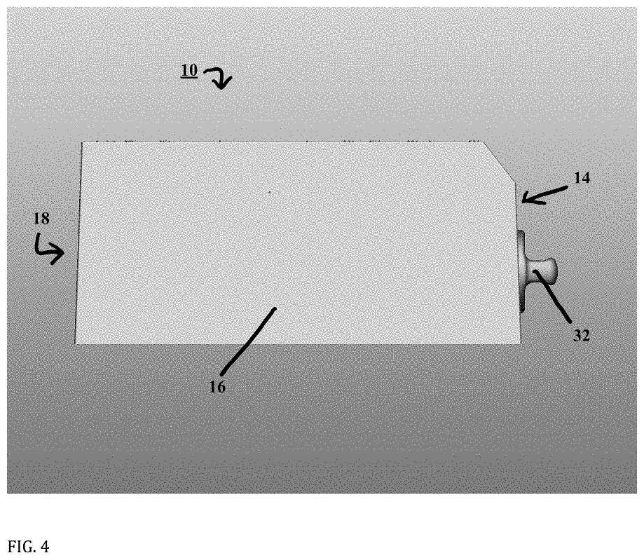

FIG. 5 is a bottom view from underneath of an exemplary embodiment of the present invention.

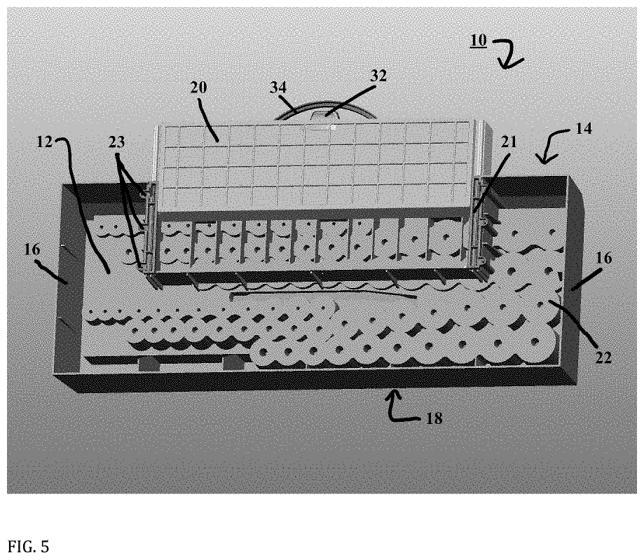

FIG. 6 is an illustration of a handle of an exemplary embodiment of the present invention.

### DETAILED DESCRIPTION

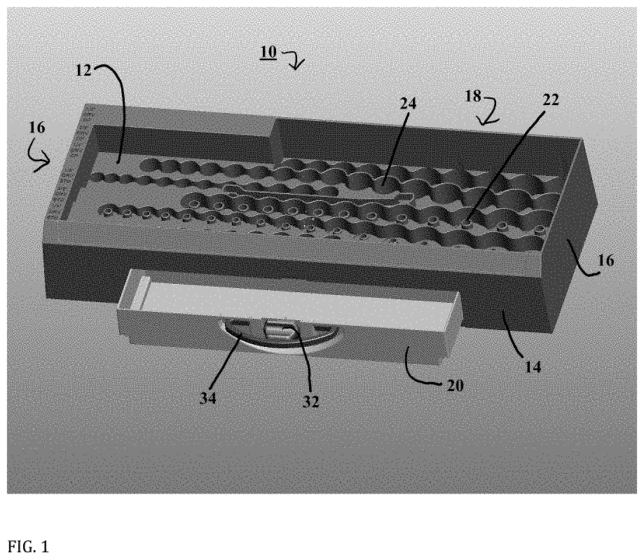

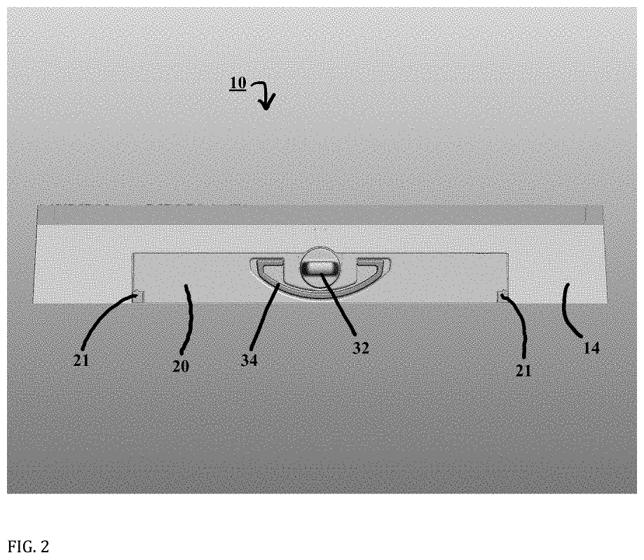

An exemplary embodiment of the present invention is represented in FIGS. 1 and 2 in which a transportable container 10 comprises a base 12, front face 14, side walls 16, and a back wall 18. Also exemplified is a drawer 20 that slides into place via a rail system 21 that is secured to the underside of the base via screws 23. An upper portion of each of the front face, side walls, and back wall form periphery edges around the base.

Although the drawings show the transportable container as substantially rectangular, it should be noted that this is a preferable embodiment. However, the transportable carrier and drawer may be of any desired geometric shape.

The base of the transportable carrier may not be substantially flat. In a preferred embodiment, the base is a set of raised cavities 22 for retaining and organizing hand tool accessories, such as, for example, sockets. Also in a preferred embodiment, the base includes an area for insertion of a drawer 20 that has the functionality to slide into the base of the invention and have a locking mechanism 32 to stay in place when desired, and handle 34 to pull drawer out when desired.

In a preferred embodiment, the hand tool accessories are sockets and the hand tool accessories for drawer placement are socket wrenches, socket extensions, and socket adaptors.

The cavities are preferably slightly larger in shape and size than a corresponding exterior shape and size of a particular hand tool accessory. In other words, the inner walls 24 of the cavity are preferably slightly larger than the exterior of a particular hand tool accessory. As such, the hand tool accessory may fit snuggly into the corresponding cavities.

The drawer is preferably sized with significant dimensions for storage of associated hand tool accessories, such as, for example, socket wrenches, socket extensions, and socket adaptors. Also, such space can provide, for example, an area for storage of other hand tool accessories that the end user feels would be efficient to maintain in close proximity to the other hand tool accessories for which the transportable carrier is being utilized.

In the various exemplary embodiments in which the hand tool accessories are sockets, it is preferred that the top cavities be cylindrical in shape.

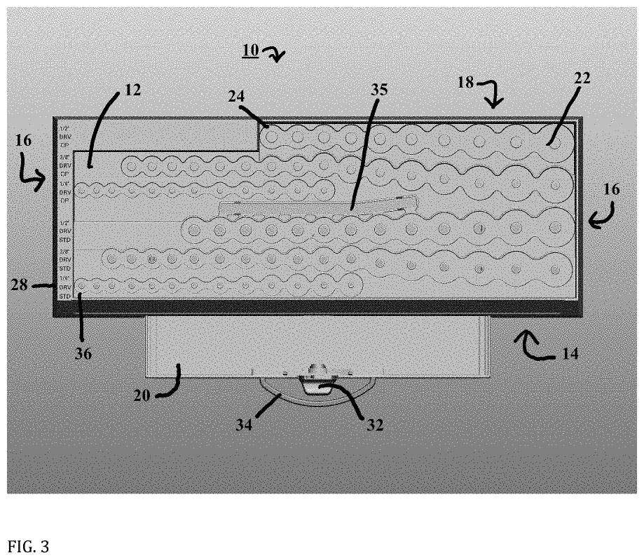

Having the base not be substantially flat, and comprise a set of raised cavities is more readily evident in FIG. 1. FIG. 1 is a perspective view of an exemplary embodiment of the present invention. As shown in FIG. 3, this embodiment has six rows 28 of cavities. The depth relative to the periphery edges of the transportable container of each row and each individual cavity may vary depending on a drive depth, shape, or size of a socket meant to be retained and stored in the respective cavity.

In a preferred embodiment, the cavities are arranged in a grid-like pattern on columns and rows. This is most evident in FIG. 3. In the exemplary embodiment shown in FIG. 3, there are six rows and twenty columns 36. In this example, the rows are arranged such that the sockets in the same row have the same drive depth and shape. However, as the sockets progress from left to right in a row, the size of the socket increases. This increase in size may be based on inches or metric measurements, but preferably, is based on standard and commercially available sizes of sockets.

As the size of the sockets increases from left to right in a row, it is preferred that the columns include one or more sockets of the same size. For example, in FIG. 3, there are two sockets in the first column on the left, meaning two sockets have the same first size. In the third column from the left, though, there are three sockets that have the same size. In the tenth column from the left, there are six sockets having the same size. Thus, it is preferred that the columns identify and organize sockets having the same size but otherwise having different shapes or drive depths.

In an exemplary embodiment, labels are placed on periphery edges of the transportable container to identify the rows, columns, or both.

Although the embodiment of the rows and columns herein is based on size and drive depth, it can also be based upon the actual shape of the corresponding socket. That is, the socket may be shaped to fit three or more points of a nut, bolt, or the like. For example, the socket may be shaped to fit a triangular shaped nut or bolt, a square shaped nut or bolt, a pentagon shaped nut or bolt, a hexagon shaped nut or bolt, etc.

The transportable container and drawer may be comprised of plastic, metal, ceramic, alloy, or a combination thereof. In a preferred embodiment, the transportable container and drawer are comprised of plastic.

In various exemplary embodiments, it is also preferred that the transportable container be three pieces of material; the main container, rails for the drawer, and the drawer. It is preferred that these three pieces be comprised of a molded plastic.

In possible embodiments, the transportable container may comprise a lid (not shown). Such a lid may be attached via one or more hinges or by sliding the lid into a set of grooves near the periphery edges.

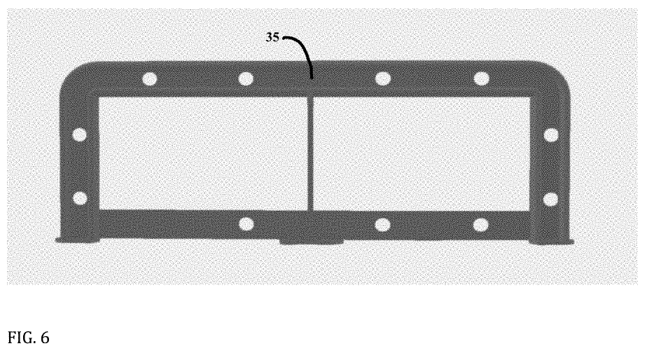

The transportable container may further comprise a first handle. The first handle 35 is comprised of plastic, metal, ceramic, alloy, or a combination thereof, and is shown in FIG. 6. In a preferred embodiment, the first handle is comprised of plastic.

When present, the first handle is arranged such that it is located substantially near the center of the base of the transportable container. Thus, the first handle may be located between columns and rows of the cavities of the transportable container.

In the various exemplary embodiments, the first handle is retractable such that when not in use, that is, being gripped to carry the transportable container, the handle may withdraw or be pushed down toward the base of the transportable container in order that it does not get in the way of an individual removing a socket or placing a socket into the transportable container.

While this invention has been described in conjunction with the specific embodiments outline above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention.

### SUMMARY

The various exemplary embodiments of the present invention comprise a transportable container for organizing various hand tools and hand tool attachments. The transportable container is comprised of a base with four walls and raised periphery edges with one of more sets of cavities for individually storing and retaining hand tool attachments. The composition of the container also includes one or more handles, one or more labels, and one or more drawers. It is preferred that the hand tool attachments be arranged systematically in order based on incremental size, drive size, or a combination thereof. The one or more labels should identify the size of an individual hand tool attachment position within the container.

### CROSS-REFERENCE TO RELATED APPLICATION

This application for a patent holds no claims to any related applications.

### REFERENCES CITED

### U.S. Patent Documents

U.S. Pat. No. 4,353,465 A October 1982 Rado
U.S. Pat. No. 4,421,230 A December 1983 Stanton
U.S. Pat. No. 4,621,738 A November 1986 DeLucchi
U.S. Pat. No. 4,711,353 A December 1987 Rozmestor
U.S. Pat. No. 5,154,544 A October 1992 Arendt
U.S. Pat. No. 5,344,012 A September 1994 Matthews
U.S. Pat. No. 5,368,164 A November 1994 Bennett et al.
U.S. Pat. No. 5,511,673 A April 1996 Folk
U.S. Pat. No. 5,573,116 A November 1996 Zink
U.S. Pat. No. 5,813,531 A September 1998 Kao
U.S. Pat. No. 6,109,437 A August 2000 Chao
U.S. Pat. No. 6,375,007 B1 April 2002 Huang
U.S. Pat. No. 6,390,298 B1 May 2002 Garro
U.S. Pat. No. 6,571,669 B2 June 2003 Benatz et al.
U.S. Pat. No. 6,695,142 B2 February 2004 Chen et al.
U.S. Pat. No. 6,808,067 B2 October 2004 Benatz et al.
U.S. Pat. No. 6,808,077 B2 October 2004 McConnell
2003/0106821 A1 June 2003 Bar-Erez
2003/0205493 A1 November 2003 Chen et al.
2004/0084342 A1 May 2004 Chang
U.S. Pat. No. 7,424,953 B2 November 2008 McCarty et al.

What is claimed:

1. A transportable container for organizing various hand tool attachments, wherein the container comprises:
a. At least one handle
b. Raised periphery edges and a base
c. At least one drawer
d. One or more sets of cavities for individually storing and retaining hand tool attachments, wherein the one or more sets of cavities have inner walls connecting to the base such that a depth of the one or more sets of cavities relate to a size of the hand tool attachments, wherein the hand tool attachments are arranged in an order based on incremental shape, size, drive size, or a combination thereof; and one or more labels identifying the shape, size, drive size, or a combination thereof of an individualized hand tool attachment position within the container.

2. The container according to claim 1, wherein the container is comprised of plastic.

3. The container base according to claim 1, wherein the container base is comprised of a single piece of plastic.

4. The drawer of container according to claim 1, wherein the drawer is comprised of a single piece of plastic.

5. The drawer of container according to claim 1, wherein the drawer is to be integrated into the container.

6. The container according to claim 1, wherein the handle is retractable.

7. The container according to claim 1, wherein the handle is plastic.

8. The container according to claim 7, wherein the handle is substantially in a center portion of the container within the periphery edges.

9. The container according to claim 1, wherein the hand tool attachments are sockets for socket wrenches.

10. The container according to claim 1, wherein the cavities are cylindrical and incrementally larger in diameter.

11. The container according to claim 10, wherein the diameter increases by one sixteenth of an inch.

12. The container according to claim 10, wherein the diameter increases by metric units.

13. The container according to claim 1, wherein the one or more sets of cavities are positioned in a substantially linear and grid arrangement comprising columns and rows.

14. The container according to claim 13, wherein the rows correspond to a drive depth of the hand tool attachment.

15. The container according to claim 14, wherein the columns correspond to the size of the hand tool attachment.

16. The container according to claim 1, further comprising a lid.
